(19) United States
(12) Patent Application Publication
(10) Pub. No.: US 2006/0133343 A1
(43) Pub. Date: Jun. 22, 2006

(54) Multi homing transport protocol on a multi-processor arrangement

(75) Inventor: Hui Huang, Beijing (CN)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/206,015

(22) Filed: Aug. 18, 2005

(30) Foreign Application Priority Data
Dec. 22, 2004 (EP) 04 030 044.6

(51) Int. Cl. H04J 3/24

(52) U.S. Cl. 370/349

(57) ABSTRACT

The invention proposes a processing arrangement (to be used in a communication device, for example), wherein the processing arrangement comprises at least one data processing unit (1), and a communication unit (2) connected to the data processing unit (1). The data processing unit (1) is configured to perform data processing, and the communication unit (2) is configured to provide a connection to the external. Furthermore, a packet transport control is used for the connection to the external, in which a plurality of addresses may be assigned to the communication unit (2). The communication unit comprises an address translating means (23) for translating packet addresses of packets sent from the external to the data processing unit and/or packets sent from the data processing units to the external. The invention also proposes a corresponding communication method.

### BACKGROUND OF THE INVENTION

1. Field of the Invention

The invention relates to a processing arrangement (to be used, for example, in a communication device) and a method, wherein a communication unit and at least one data processing unit are separately provided and a multi-homing packet transport protocol is used.

2. Description of the Related Art

This invention is related to multi-homing packet transport protocols in connection with multi-processor communication devices. A multi-homing packet transport protocol is a transport protocol which supports multi-homed nodes, i.e., nodes which each can be reached under several addresses. An example for such a transport protocol is SCTP (Stream Control Transport Protocol).

Transport layer multi-homing and mobility have been proposed in new Internet transport protocols, such as the SCTP mentioned above. The feature of multi-homing can be utilized in multi-homed mobile devices (such as a mobile device having simultaneous 2G (second generation), 3G (third generation), WLAN (Wideband Local Area) and Bluetooth accesses), for example), and provides the benefit for redundancy, load balancing and mobility. SCTP has been received much attention due to its attractive features of multi-homing and multi-streaming. It has been proposed to be a transport protocol for multimedia transmission in addition to signalling transmission.

Additionally, in order to increase the processing capability, multi-processor architecture has been used for mobile phones. Normally, one processor handles the communication processing and is called COM engine, and the other processor called APE (Application Processor Environment) engine handles application processing for various applications that may be running on the terminal. Accordingly, two Operation Systems are built on top of the two processors, respectively.

A multi-homed SCTP endpoint can be represented as a list of SCTP transport addresses on the machine that share a single SCTP port. Then, the SCTP endpoint can be denoted by a list of addresses and one port number:

SCTP endpoint=[address 1, address 2, . . . address n: port number]

Therefore, there exist multiple paths between a multi-homed SCTP endpoint and its peer. Normally, the sender transmits data to its primary path, while in the case of failure of the primary path, the sender can switch its transmitting path to an alternative path. SCTP can provide a kind of mobility at the transport layer by adding/deleting an address. To support multi-homing, SCTP has a new system call bindx to bind multiple local addresses to its port, and send its local address list to the remote peer during association establishment. SCTP is an end-to-end transport protocol, and a multi-homed SCTP endpoint can establish multiple paths to the remote SCTP peer. For this reason, SCTP must provide its address information to its peer in the so-called INIT/INIT-ACK chunks during the association setup phase.

However, although a dual processor mobile phone is a multi-homed machine, APE on the mobile phone does only know its local interface to COM engine and is not aware of the interfaces to the external network. Thus the SCTP applications running on the APE can not inform its peer about its multiple address information. That is, the multi-homing feature of SCTP can not be realized.

This problem does not only occur in connection with SCTP, but also with other multi-homing packet transport protocols, such as DCCP (Datagram Congestion Control Protocol) or TCP-MH (Transport Control Protocol—Multi-Homing, the TCP protocol being augmented by multi-homing features), for example.

### SUMMARY OF THE INVENTION

Hence, it is an object of the present invention to solve the problem mentioned above and to enable support transport layer multi-homing and mobility for a dual processor mobile phone.

This object is solved by a processing arrangement, comprising at least one data processing unit, and a communication unit connected to the data processing unit, wherein the at least one data processing unit is configured to perform data processing and the communication unit is configured to provide a connection to the external, a packet transport control is used for the connection to the external, in which a plurality of addresses may be assigned to the communication unit, and the communication unit comprises an address translating means for translating packet addresses of packets sent from the external to the data processing unit and/or packets sent from the data processing units to the external.

Alternatively, the above object is solved by a method for performing communication of a processing arrangement comprising at least one data processing unit, and a communication unit connected to the data processing unit and configured to provide a connection to an external node, wherein a packet transport control is used for the connection between the communication unit and the external node, in which packet transport protocol a plurality of addresses may be assigned to the communication unit, the method comprising the step of translating packet addresses of packets sent from the external node to the data processing unit and/or packets sent from the data processing units to the external node.

Furthermore, according to the invention a communication unit for providing a connection to the external is provided, wherein a packet transport control is used for the connection to the external, in which a plurality of addresses may be assigned to the communication unit, and the communication unit comprises an address translating means for translating packet addresses of packets sent from the external to at least one data processing unit and/or packets sent from at least one data processing unit to the external.

Thus, according to the invention a translation of addresses is performed, namely between the plurality of external addresses assigned to the processing arrangement (which is used, for example, in a communication device) and the internal address of the data processing unit, e.g., the APE processor. In this way, for example, an external host can receive the packets from one of the addresses of the processing arrangement, and send packets to one of the addresses of the processing arrangement, but for the data processing unit, all sent packets comprises only its own (internal) address as the source address, and all received packets comprises only its own address as destination address.

That is, the data processing unit can use the features of the multi-home packet transport protocol (such as SCTP) normally, the function of the address translation is fully transparent to it.

Therefore, transport layer multi-homing and mobility can easily be provided for dual-processor communication devices.

Sending to and receiving from “external”, as used in the present application, is to be understood such that packets are sent to or received from external nodes or hosts, i.e., nodes which are separate from the processing arrangement (the communication device).

Further advantageous developments are set out in the dependent claims.

For example, the address translating means may comprise a packet receiving means for receiving a packet transmitted via a transport layer, wherein the packet receiving means detects whether the received packet is an incoming or an outgoing packet.

Furthermore, the address translating means may replace a source address of a packet received from the data processing unit by a selected one of the plurality of addresses of the communication unit in a packet sent from the data processing unit to the external.

The address translating means may comprise a source address selecting means for selecting a source address of the plurality of addresses of the communication unit.

The address translating means may comprise means for replacing a destination address of a packet received from the external by an address of the data processing unit.

The address translating means may comprise packet type detecting means for detecting the type of a packet and for forwarding the packet to an application part of the communication unit depending on the type of the packet.

The packet type detecting means may detect the type of a packet by detecting a port number of the packet.

The address translating unit may detect whether an outgoing packet comprises a network transport protocol initialization message, and, if it comprises an initialization message, it may include the addresses of the communication unit into the initialization message.

The communication unit may change at least one of its addresses, and the translating unit may perform signalling exchange with the external regarding the address change. Upon performing signalling exchange with the external, the translating unit may include the at least one changed address into a packet transport protocol message.

Transport protocol may be, for example, Stream Control Transport Protocol (SCTP), Datagram Congestion Control Protocol (DCCP) or Transport Control Protocol—Multi-Homing (TCP-MH).

The processing arrangement may comprise a first and a second processor, wherein the first processor comprises the data processing unit and the second processor comprises the communication unit.

The processing arrangement may be a chipset for example, which is designed for use in a communication device or other suitable devices.

### BRIEF DESCRIPTION OF THE DRAWINGS

The invention is described by referring to the enclosed drawings, in which:

FIG. 1 shows an external host and a mobile device according to an embodiment of the present invention, and

FIG. 2 shows function modules in an SCTP layer of a COM engine of the mobile device according to the embodiment of the present invention.

### DETAILED DESCRIPTION OF THE PREFERRED EMBODIMENT

In the following, a preferred embodiment of the present invention is described by referring to the attached drawings.

In the embodiment described in the following, SCTP (Stream Control Transport Protocol) is used as an example for a multi-homing packet transport protocol. An SCTP protocol data unit consists of a common header including source and destination addresses, verification tag and checksum, and of one or more so-called chunks. A chunk is a unit of information within an SCTP packet, consisting of a chunk header and chunk-specific content. There may be data chunks which include user data, and control chunks, which deliver control data. Examples for such control chunks are INIT chunk and INIT-ACK chunk mentioned earlier.

According to the present embodiment, a simplified NAT (Network Address Translator) as an example for an address translating means is used in order to provide SCTP multihoming support on dual processor mobile device. Furthermore, a module named SCTP-ALG (Application Layer Gateway) with NAT is added to the COM (Communication Module) engine (as an example for a communication unit) of a dual processor mobile phone. NAT would do IP address translation for the outgoing/incoming packets. When an SCTP packet goes out from the APE (Application Processor Environment) engine as an example for a data processing unit, its source address is the IP address of the APE engine. When packets arrive at the COM engine, the source address of SCTP packet will be translated to one address of the COM engine such that it looks like packets are sent out from COM directly. In this way, the mobile host can inform the external host the addresses on the mobile device. In addition, mobility can be supported by sending special signaling of add/delete IP addresses from SCTP-ALG to the remote host, as will be described later.

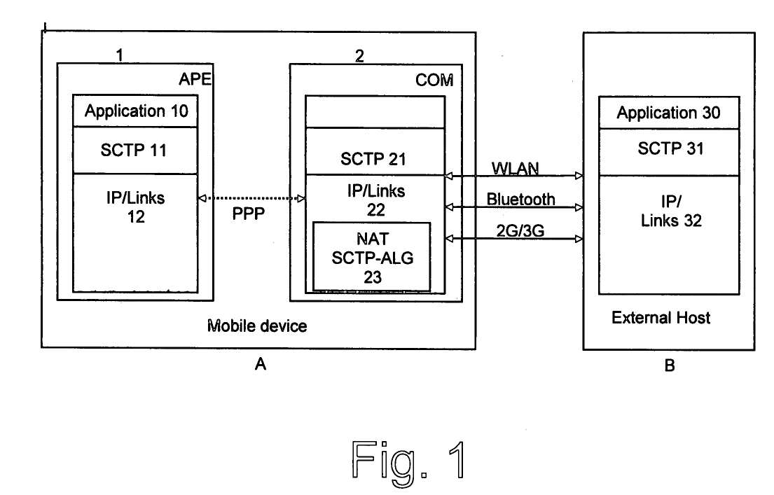

FIG. 1 shows a detailed example of the structure of a mobile device A comprising NAT and SCTP-ALG according to an embodiment of the present invention in connection with an external host B.

In detail, the mobile device A comprises an APE engine 1 and a COM engine 2. The APE engine 1 comprises an application block 10, an SCTP block 11 and an IP/links block 12. The COM engine 2 comprises an SCTP block 21, an IP/links block 22 and additionally a NAT/SCTP-ALG block 23 including the NAT and SCTP-ALG function modules according to the present embodiment, which will be described in the following in more detail. The NAT/SCTP-ALG block is arrangement within the IP/links block 22. The APE and COM engine are connected via a ppp (point-to-point protocol) link. Basically, APE handles application processing and COM handles communication to the external hosts (i.e., the communication to the external).

As shown in FIG. 1, the NAT and SCTP-ALG function modules are located in the COM Linux OS (Operating System) of the Mobile Device. When a SCTP application is initiated from the APE engine 1, SCTP packets are transmitted between the APE engine 1 and the external host (remote peer) B. When SCTP packets go out from APE, its source address is the IP address of the APE engine. When packets arrive at the COM engine, the source address of SCTP packet will be translated to one address of COM such that it looks like packets are sent out from COM directly. Then, an external host will send its response packets to COM. When these packets arrive at COM, the NAT SCTP-ALG function module 23 (in detail, the NAT function module thereof) will translate the destination IP address to the IP address of APE.

In order to let the remote SCTP peer know the multiple addresses of mobile device, the NAT and SCTP-ALG function module 23 (in detail, the SCTP-ALG function thereof) adds the address information of the COM engine into an INIT chunk. Namely, as mentioned above, upon establishing an SCTP association, the APE engine sends an INIT chunk to the external host. Thus, when the COM engine 2 receives a SCTP INIT chunk from the APE engine 1, it will remove the APE's address and add the COM's address in the INIT chunk and then forward it to the remote peer.

On the other hand, the SCTP endpoint in the APE engine is able to be aware of all IP addresses of the external SCTP endpoint B. Namely, the external SCTP endpoint informs the APE engine of all IP addresses in SCTP INIT_ACK chunk. The chunks inside SCTP packet from external SCTP endpoint are not changed by the COM engine. For this reason, the proposed scheme will not affect the Heartbeat function of SCTP. The Heartbeat function defined for SCTP serves to check the reachability of a particular destination transport address defined in the present association. For this, a so called Heartbeat Request (HEARTBEAT) is sent, which is answered by a Heartbeat Acknowledgment (HEARTBEAT ACK).

Additionally, for mobility support, SCTP-ALG should be aware of changes of the interfaces of COM. When COM activates or deletes an interface, SCTP-ALG sends Add/Delete IP signaling (ASCONF/ASCONF-ACK) to the remote peer and notifies the addresses changes. That is, the SCTP-ALG sends an ASCONF (Address Configuration) chunk including a parameter “Add IP address” or “Delete IP address” to the remote peer, which responds with an ASCONF-ACK (Address configuration acknowledgement) chunk. Noted that if COM wants to send an ASCONF chunk or an ASCONF-ACK chunk to the corresponding association, the COM engine keeps a record of all active associations, but it may not maintain all of the information of each association, only the address information and the timer of Add-ip. Moreover, since COM is inside of a SCTP client of mobile terminal, so normally, it will not have many associations at the same time.

In summary, the functionality of NAT and SCTP-ALG according to the present embodiment is listed below:

NAT:

Performs IP address translation for the outgoing/incoming IP packets.
Source address selection of SCTP packet is performed in NAT according to the destination address of the remote SCTP peer.
   SCTP-ALG:
Captures the INIT chunk and translate the IP addresses in INIT to the addresses of the COM engine.
Performs signal exchange with the remote peer for addresses changes happened at the COM engine.

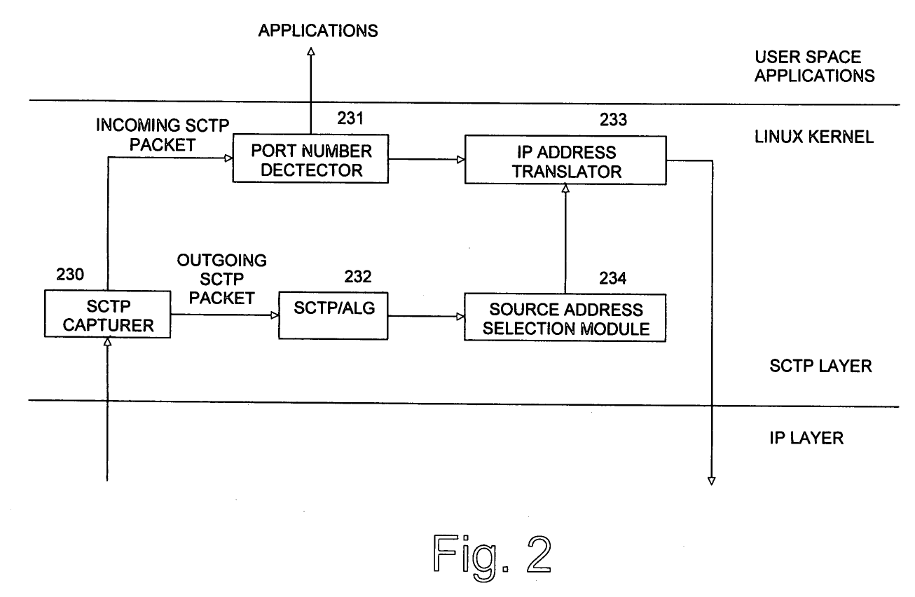

In the following, a detailed implementation of the NAT and SCTP-ALG function modules according to the present embodiment is described by referring to FIG. 2.

According to the present embodiment, the SCTP protocol stack is at the Linux kernel. Therefore, the NAT and SCTP-ALG function modules are implemented in the kernel and then co-work with SCTP protocol stack. In this way, the NAT and SCTP-ALG is completely transparent to user layer applications. That is, the user layer applications are not aware of the existence of the NAT and SCTP-ALG.

FIG. 2 shows function modules in the Linux kernel, i.e., in the SCTP layer, which are part of the NAT and SCTP-ALG module 23 shown in FIG. 1. As mentioned above, the SCTP layer is located in the Linux kernel between the user space applications and the IP layer (i.e., transport layer) of the protocol stack of the COM engine. In the following, the functions modules are described by indicating the relationships between them.

(1) SCTP capturer 230:

The SCTP capturer 230 receives an SCTP packet from IP layer, which may be an SCTP packet sent by the APE engine (outgoing packet) or an SCTP packet sent by a remote host (incoming packet). Before the SCTP packet is passed to the normal SCTP receiver (located in the upper layer, i.e., the user space applications of the COM engine with respect to SCTP control messages, or in the APE engine) or forwarded to external hosts (via the IP layer), the SCTP capturer 230 judges whether the packet is an outgoing SCTP packet to external network or an incoming SCTP packet from external network. For example, this is effected by evaluating the destination and/or source addresses of the packet.
   (2) SCTP-ALG module 231:
A. If the SCTP is an outgoing SCTP packet, the packet is passed to the SCTP-ALG module 231. The SCTP-ALG module 231 checks whether it is an INIT chunk or not. If it is an INIT chunk, the SCTP-ALG module 231 will add the external address information of the COM engine (i.e., the IP addresses under which the COM engine is reachable) to the address list in INIT chunk. It is noted that this addition leads to a change of the payload of the SCTP packet. Hence, the checksum of the SCTP packet should be recalculated and rewritten in the corresponding header field of the SCTP packet.
B. A further example for an outgoing packet is an ASCONF chunk or an ASCONF-ACK chunk including Add/delete IP signaling, as described above, which is sent to the remote host for mobility support. This action can be triggered from IP layer or Link layer, when the mobile device performs a handover to a new access network. Then, the SCTP-ALG module 231 sends an ASCONF chunk to the remote host with changed addresses of the COM engine.
   (3) Source address selection module 234:
The SCTP-ALG module 232 forwards the packets to a source address selection module 234. The source address selection module 234 of the NAT selects a source address for the outgoing SCTP packet based on the destination address of the packet or the bandwidth of the access link. The outgoing packet is then forwarded to an IP address translator 233 described later. The selection of the source address can be performed in the following way, for example. In detail, the source address selection is based on the destination address. This function is effected by selecting a routing entry from the routing table which has a route to the destination. The source address or the interface address is read from the routing entry.
   (4) Port number detector 231:
If the SCTP capturer 230 receives an incoming SCTP packet, this packet is forwarded to a port number detector 231. The port number detector 231 is used to judge whether the SCTP packet should be terminated at the COM engine or forwarded to the APE engine. Namely, with respect to the design of dual processor device, server applications are running on the COM engine and client applications are running on the APE engine. Normally, the server applications (running on the COM engine) use well-known port numbers below 1024. Therefore, if the destination port number is between 0-1024, then the SCTP packet will be passed to the application layer (as indicated by the arrow in FIG. 2 directed upwards), otherwise the SCTP packet goes to an IP address translator 233 described in the following.
Thus, depending on the judgment of the port number detector 231, the incoming SCTP packet is forwarded to the applications or to an IP address translator 233 described in the following.
   (5) IP address translator 233:
The translator 233 performs the IP address translation for both outgoing and incoming packets. For outgoing SCTP packet, the source address is translated to one of the IP addresses of the external interface (i.e., one of the IP addresses of the COM engine). For an incoming SCTP packet, the destination address is translated to the address of APE engine.
Thereafter, the packet is returned to the IP layer, where it is forwarded to the remote peer or to the APE engine 1, depending on the destination address.

Thus, according to the embodiment described above, a scheme is applied by which an SCTP association between user applications running on an APE engine of a dual processor and an external host can easily be provided.

In detail, the address translation performed by the corresponding function modules of the COM engine is transparent to upper layer application. It is no more communication between APE and COM engines necessary than it is in the prior art APE and Com engines.

Furthermore, no changes on SCTP protocol stack at the APE engine or the external host are necessary, although for simplifying the implementation of the scheme according to the embodiment, SCTP-ALG may utilize some function of the SCTP protocol stack in suitable manner.

The invention is not limited to the embodiment described above, and various modification are possible.

For example, the invention is not limited to the use of SCTP. Any transport layer protocol which has multi-homing support (e.g. SCTP, DCCP, TCP-MH) can utilized this scheme on the dual processor mobile devices

Moreover, the dual-processor mobile phone described in the embodiment above is only an example for a communication device. That is, the invention can be applied to any communication device in which the communication function and other functions are separated between different entities.

In particular, the communication device is not limited to a mobile communication device. The invention can be applied to other devices in which a processing arrangement comprising at least one data processing unit and a communication unit is used. For example, such a processing arrangement may be a chipset or may be a part of a chipset to be used for a communication device or the like.

Furthermore, the data processing functions may also be performed in more than one entity (e.g., there may be two or more APE processors). In this way, each APE engine (data processing unit) may have its own address, and the COM engine has to correspondingly translate the addresses for the plurality of APE engines. In this way, a complete NAT-PT (Network address translation and port number translation) function should be provided at the COM engine, the COM engine needs to record the status of each SCTP association on multiple APEs and then assign different port numbers to the associations.

Further, in the embodiment described above, Linux was described as an example for an operating system for the APE and COM engines. However, any suitable operating system can be used instead.

Moreover, the function modules shown in FIG. 2 can be realized by software, but can also be suitable hardware.

1. A processing arrangement, comprising:
at least one data processing unit; and
a communication unit connected to the at least one data processing unit; wherein
the at least one data processing unit is configured to perform data processing and the communication unit is configured to provide a connection to the external,
a packet transport control is used for the connection to the external, in which a plurality of addresses may be assigned to the communication unit, and
the communication unit comprises an address translating means for translating packet addresses of packets sent from the external to the at least one data processing unit and/or packets sent from the at least one data processing unit to the external.

2. A processing arrangement according to claim 1, wherein the address translating means comprises a packet receiving means for receiving a packet transmitted via a transport layer, the packet receiving means being configured to detect whether the received packet is an incoming or an outgoing packet.

3. A processing arrangement according to claim 1, wherein the address translating means comprises means for replacing a source address of a packet received from the at least one data processing unit by a selected one of the plurality of addresses of the communication unit in a packet sent from the at least one data processing unit to the external.

4. A processing arrangement according to claim 3, wherein the address translating means comprises source address selecting means for selecting a source address of the plurality of addresses of the communication unit.

5. A processing arrangement according to claim 1, wherein the address translating means comprises means for replacing a destination address of a packet received from the external by an address of the at least one data processing unit.

6. A processing arrangement according to claim 1, wherein the address translating means comprises packet type detecting means for detecting a type of a packet and for forwarding the packet to an application part of the communication unit depending on the type of the packet.

7. A processing arrangement according to claim 6, wherein the packet type detecting means detects the type of the packet by detecting a port number of the packet.

8. A processing arrangement according to claim 1, wherein the address translating means comprises means for detecting whether an outgoing packet comprises a network transport protocol initialization message, and including the addresses of the communication unit into the initialization message, when the outgoing packet comprises the initialization message.

9. A processing arrangement according to claim 1, wherein the communication unit comprises means for changing at least one of the plurality of addresses, and the translating means comprises means for performing signalling exchange with the external node regarding the address change.

10. A processing arrangement according to claim 9, wherein the means for performing signalling exchange with the external is configured to include the at least one changed address into a packet transport protocol message.

11. A processing arrangement according to claim 1, wherein the transport protocol is one of Stream Control Transport Protocol (SCTP), Datagram Congestion Control Protocol (DCCP) and Transport Control Protocol—Multi-Homing (TCP-MH).

12. A processing arrangement according to claim 1, comprising a first and a second processor, wherein the first processor comprises the at least one data processing unit and the second processor comprises the communication unit.

13. A communication device comprising:
at least one data processing unit; and
a communication unit connected to the at least one data processing unit; wherein
the at least one data processing unit is configured to perform data processing and the communication unit is configured to provide a connection to the external,
a packet transport control is used for the connection to the external node, in which a plurality of addresses may be assigned to the communication unit, and
the communication unit comprises an address translating means for translating packet addresses of packets sent from the external to the at least one data processing unit and/or packets sent from the at least one data processing unit to the external.

14. A method for performing communication of a processing arrangement comprising at least one data processing unit, and a communication unit connected to the at least one data processing unit and configured to provide a connection to an external node, wherein
a packet transport control is used for the connection between the communication unit and the external node, in which packet transport protocol a plurality of addresses may be assigned to the communication unit, the method comprising the step of:
translating packet addresses of packets sent from the external node to the at least one data processing unit and/or packets sent from the at least one data processing unit to the external node.

15. A method according to claim 14, wherein the address translating step comprises the steps of:
receiving a packet transmitted via a transport layer; and
detecting whether the received packet is one of an incoming packet and an outgoing packet.

16. A method according to claim 14, wherein the address translating step comprises the step of:
replacing a source address of a packet received from the at least one data processing unit by a selected one of the plurality of addresses of the communication unit in a packet sent from the at least one data processing unit to the external node.

17. A method according to claim 16, wherein the address translating step comprises the step of:
selecting a source address of the plurality of addresses of the communication unit.

18. A method according to claim 14, wherein the address translating step comprises the step of:
replacing a destination address of a packet received from the external node with an address of the at least one data processing unit.

19. A method according to claim 14, wherein the address translating step comprises the steps of:
detecting a type of a packet; and
forwarding the packet to an application part of the communication unit depending on the type of the packet.

20. A method according to claim 19, wherein the packet type detecting step detects the type of a packet by detecting a port number of the packet.

21. A method according to claim 14, wherein the address translating step comprises the steps of:
detecting whether an outgoing packet comprises a network transport protocol initialization message; and
including the addresses of the communication unit into the initialization message, when the outgoing packet comprises the initialization message.

22. A method according to claim 14, further comprising the steps of:
changing at least one of the plurality of addresses of the communication unit, and performing signalling exchange with the external node regarding the address change.

23. A method according to claim 22, wherein the signalling exchange performing step comprises the step of:
including the at least one changed address in a packet transport protocol message.

24. A method according to claim 14, wherein the transport protocol is one of Stream Control Transport Protocol (SCTP), Datagram Congestion Control Protocol (DCCP) and Transport Control Protocol—Multi-Homing (TCP-MH).

25. A computer program product for a computer, comprising software code portions for executing, when the program is run on a computer, a method for performing communication of a processing arrangement comprising at least one data processing unit, and a communication unit connected to the at least one data processing unit and configured to provide a connection to an external node, wherein a packet transport control is used for the connection between the communication unit and the external node, in which packet transport protocol a plurality of addresses may be assigned to the communication unit, the method comprising the step of:
translating packet addresses of packets sent from the external node to the at least one data processing unit and/or packets sent from the at least one data processing unit to the external node.

26. The computer program product according to claim 25, wherein the computer program product comprises a computer-readable medium on which the software code portions are stored.

27. A communication unit for providing a connection to the external, wherein
a packet transport control is used for the connection to the external, in which a plurality of addresses may be assigned to the communication unit, and
the communication unit comprises an address translating means for translating packet addresses of packets sent from the external to at least one data processing unit and/or packets sent from at least one data processing unit to the external.

28. A communication unit according to claim 27, wherein the address translating means comprises a packet receiving means for receiving a packet transmitted via a transport layer, the packet receiving means being configured to detect whether the received packet is an incoming or an outgoing packet.

29. A communication unit according to claim 27, wherein the address translating means comprises means for replacing a source address of a packet received from the at least one data processing unit by a selected one of the plurality of addresses of the communication unit in a packet sent from the at least one data processing unit to the external.

30. A communication unit according to claim 29, wherein the address translating means comprises source address selecting means for selecting a source address of the plurality of addresses of the communication unit.

31. A communication unit according to claim 27, wherein the address translating means comprises means for replacing a destination address of a packet received from the external by an address of the at least one data processing unit.

32. A communication unit according to claim 27, wherein the address translating means comprises packet type detecting means for detecting a type of a packet and for forwarding the packet to an application part of the communication unit depending on the type of the packet.

33. A communication unit according to claim 32, wherein the packet type detecting means is configured to detect the type of the packet by detecting a port number of the packet.

34. A communication unit according to claim 27, wherein the address translating means comprises means for detecting whether an outgoing packet comprises a network transport protocol initialization message, and including the addresses of the communication unit into the initialization message, when the outgoing packet comprises the initialization message.

35. A communication unit according to claim 27, wherein the communication unit comprises means for changing at least one of the plurality of addresses, and the translating means comprises means for performing signalling exchange with the external node regarding the address change.

36. A communication unit according to claim 35, wherein the means for performing signalling exchange with the external is configured to include the at least one changed address into a packet transport protocol message.

37. A communication unit according to claim 27, wherein the transport protocol is one of Stream Control Transport Protocol (SCTP), Datagram Congestion Control Protocol (DCCP) and Transport Control Protocol—Multi-Homing (TCP-MH).
